(19) United States
(12) Patent Application Publication
(10) Pub. No.: US 2012/0034392 A1
(43) Pub. Date: Feb. 9, 2012

(54) Coating Method

(75) Inventors: Clemens LUCHNER, Uebersee (DE); Marc Kronenberg, Muenchen (DE)

(73) Assignee: Bayerische Motoren Werke Aktiengesellschaft, Muenchen (DE)

(21) Appl. No.: 13/272,606

(22) Filed: Oct. 13, 2011

Related U.S. Application Data
(63) Continuation of application No. PCT/EP2010/002190, filed on Apr. 8, 2010.

(30) Foreign Application Priority Data
May 13, 2009 (DE) 10 2009 021 127.6

(51) Int. Cl. B05D 3/06; B05D 3/02; B05D 7/22

(52) U.S. Cl. 427/556; 427/318; 427/554; 427/319; 427/320; 427/239

(57) ABSTRACT

A method is provided for coating a surface of an Fe-based, hardenable sintered, sinter-forged or forged component, and in particular for internally coating the large end bore of a motor vehicle connecting rod with a bearing coating, wherein the coating material applied to the component surface is converted to a molten state during the coating process. A material bond, which is durable even under high loads, is attained between the coating and the base material of the sintered or forged component without any disturbing residual stresses by a simple manufacturing method due to the fact that during the coating process the component surface is briefly heated in the untreated state of the component above the austenitization temperature to a temperature level having a significantly increased diffusion rate within the limits of the outer edge zone having less carbon for reasons relating to the manufacturing process.

### CROSS-REFERENCE TO RELATED APPLICATIONS

This application is a continuation of PCT International Application No. PCT/EP2010/002190, filed Apr. 8, 2010, which claims priority under 35 U.S.C. §119 from German Patent Application No. DE 10 2009 021 127.6, filed May 13, 2009, the entire disclosures of which are herein expressly incorporated by reference.

### BACKGROUND AND SUMMARY OF THE INVENTION

The invention relates to a method for coating a surface of a hardenable, Fe-based sintered, sinter-forged or forged component, and in particular for internally coating the large end bore of a motor vehicle connecting rod with a bearing coating.

In order to provide a sintered or forged connecting rod of this type with a bearing coating on the interior surface of the large end bore, DE 43 03 592 A1 provides the use of a thermal spraying method. In this thermal spraying method, bearing material is spread on the interior surface of the bore in the form of partially or totally molten spray particles, and remains adhered to said interior surface primarily due to a mechanical interlocking. For reasons relating to an intimate positive adhesion, the interior surface of the bore is only rough machined prior to the coating operation. On the other hand, no precisely fitting reworking of the untreated component at the bearing bore is required. The drawback with such sintered or forged connecting rods has proven to be that the bonding connection of the bearing coating, applied in this manner, has only a very limited fatigue endurance strength under the harsh operating conditions of motor vehicle engines.

Furthermore, it is known from DE 10 2004 018 921 A1 to heat-treat the bearing bore of a sintered, sinter-forged or forged connecting rod by way of a laser-based build-up welding or soldering method. The method is performed such that, by means of a plain bearing coating, not only the coating material is applied in the molten state, but also the interior surface of the bore that is to be coated is partially or completely molten near the surface, subject to the local effect of the laser beam. This is done in order to obtain a highly fatigue resistant, material bonding between the bearing coating and the interior surface of the bore that is pretreated for reasons relating to continuous wetting.

However, the result of such a coating method is that residual stresses remain in the finish coated component owing to the local partial or complete melting of the base material. These residual stresses have an adverse effect on the bonding of the bearing layer on the base material and can be eliminated, if at all, only by means of costly countermeasures.

In contrast, the object of the invention is to develop the coating method of the type described above such that a material bond, which is durable even under high loads, is attained between the coating and the base material of the sintered or forged component without any disturbing residual stresses with the use of a simple manufacturing method.

This and other objects are achieved by providing a method for coating a surface of an Fe-based, hardenable sintered, sinter-forged or forged component, and in particular for internally coating the large end bore of a motor vehicle connecting rod with a bearing coating. The coating material applied to the component surface is converted to a molten state during the coating process. During the coating process the component surface is briefly heated in the untreated state of the component above the austenitization temperature to a temperature level having a significantly increased diffusion rate within the limits of the outer edge zone having less carbon for reasons relating to the manufacturing process

The invention recognizes that in the methods known from the prior art, a martensitic microstructural transformation takes place in the edge zones that are near the surface of the base material and that are present after machining the untreated component. The transformation takes place when these edge zones are heated up to a temperature level that is adequate enough for a predominantly cohesive and not just positive, bonding of the coating material. The invention further recognizes that such a martensitic transformation is the cause for the undesired residual stresses in the bonding area of the finished component. In view of these recognitions, the invention provides that during the coating process the surface of the component is heated as far as into the temperature range of a fast, seamlessly cohesive diffusion bonding in the still original edge zone without prior machining, thus, still in the untreated state of the component, but simultaneously a martensitic hardening at this location of the base material is largely suppressed due to the production dependent, lower carbon content at said location. The result is a surface coated component with a continuously cohesive diffusion bonding between the coating material and the base material. The diffusion bonding does not include disturbing residual stresses and is consequently durable.

With respect to a control of the heat input that is especially accurate in terms of location and quantity, the coating takes place expediently subject to the effect of a laser beam, and in particular subject to heating the outer edge zone at most up to the solidus temperature, in order to avoid the formation of tribologically unfavorable Fe phases in the coating. In this case it is also possible to dispense with a pre-treatment of the surface of the blank to be coated. This is because any impurities, like parting agents or preservatives, are simultaneously vaporized under the influence of the laser beam.

A preferred coating material that has proven to be especially good predominantly for connecting rods of motor vehicles is a Cu, Sn or Al based alloy.

Finally, in order to improve the mechanical properties, it is advisable to post-compact the component prior to the coating operation.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view of a motor vehicle connecting rod with a bearing layer, which is applied on the interior surface of the large end bore; and

FIGS. 2a, 2b show the microstructure of a motor vehicle connecting rod from FIG. 1 in the area of the bearing layer in the case of a conventional coating (a) and in the case of a coating according to the inventive method (b).

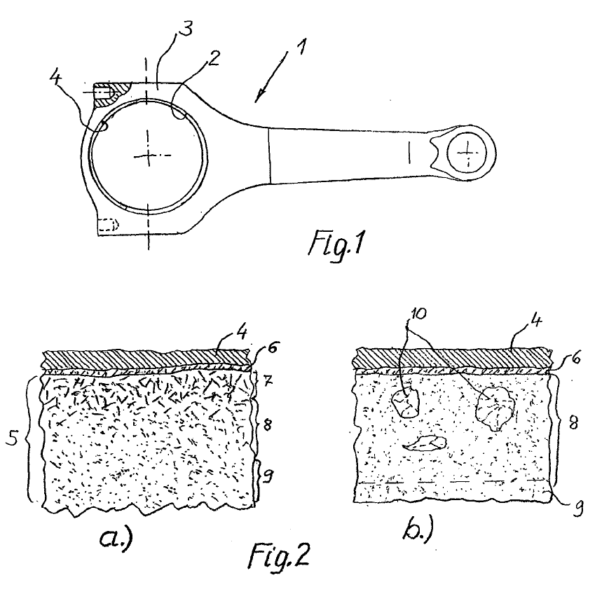

### DETAILED DESCRIPTION OF THE DRAWINGS

A motor vehicle connecting rod 1, which is shown in the Figures, is produced in a conventional manner as a sintered, sinter-forged or forged component made of a hardenable, Fe-based base material having a C content between 0.3 and 0.8%. For example, it may be made of a sintering material with 3% Cu, 0.5% C, 0.3% MnS, and the rest Fe or it may be made of a steel material (C70S6 BY) with 0.69-0.73% C, 0.15-0.25% Si, 0.55-0.60% Mn, maximum 0.045% P, 0.06-0.07 S, 0.1-0.15% Cr, 0.04-0.08% Ni and the rest Fe.

The interior surface 2 of a large end bore 3 has a coating 4 made of a tribologically good bearing material, such as a CuZn31Si1, a CuNi2Si or a SnSbCu alloy.

In conventional thermal coating methods, such as flame spraying, where the coating material is applied in the molten state on the interior surface of the connecting rod, the result is a predominantly positive interlocking between the bearing coating layer 4 and the base material of the large end bore 3, which is at least rough machined prior to the coating operation on the interior surface 2 in view of an improved positive bonding.

According to another known coating method, which is described in detail with reference to FIG. 2a, in the form of a laser-based powder, wire or melting method, not only the coating material is melted by an energy rich laser beam, but at the same time the interior surface 2 of the connecting rod is locally heated to such an extent and, thus, the diffusion rate is increased to such an extent, that a distinctive diffusion zone 6 is formed between the coating 4 and the base material 5. This results in attaining a high quality and, in particular, excellent material bonding. A continuous wetting with the molten coating material is guaranteed by first cleaning the untreated component of parting agents and preservatives and other impurities on the interior surface 2 of the large end bore 3 of the connecting rod by removing the edge zone near the surface.

As a result of the brief local heating and the correspondingly rapid cooling of the base material abutting the diffusion zone 6, this microstructural region 7 experiences a martensitic transformation that merges by way of a bainitic structure 8 (bainite) with the original base structure 9. However, such a coating method produces residual stresses in the finish coated connecting rod 1, which in turn results in a degradation of the diffusion bonding of the bearing layer 4.

With the exemplary method according to the invention, which is described in detail below with reference to FIG. 2b and which, in turn, is a laser powder, laser wire or laser melt method, the disturbing residual stresses are eliminated by a simple manufacturing method wherein, despite a material bonding of the bearing layer, a martensitic transformation in the coating-sided edge zone of the base material is suppressed as a cause of the residual stresses. In addition, the method utilizes the fact that the carbon content in the untreated state of the sintered or forged component 1 declines significantly, that is, falls below 0.2% in the edge zone near the surface for reasons relating to the manufacturing process. This low carbon edge zone is left in the untreated component and coated directly with the molten coating material and, at the same time, is briefly heated, subject to the local, energy rich laser radiation, as far as above the austenitization temperature A_{c1} up to a temperature range having a significantly increased diffusion rate. In this case the adhering impurities are vaporized by the impinging laser beam, so that the result is a continuous wetting and then cohesive diffusion bonding of the interior surface 2 of the connecting rod with the coating material. However, due to the low carbon content, a martensitic transformation in the edge zone of the base material that is coated in this way is suppressed. Instead, this region has, directly adjacent to the diffusion zone 6, a bainitic structure 8 (bainite) that exhibits embedded ferrite islands 10 and merges inwards with the original, carbon rich base structure 9. The heat input of the laser beam during the coating operation is adjusted such that the solidus temperature in the edge zone is not exceeded in order to avoid tribologically unfavorable Fe phases in the coating 4.

This approach makes it possible to achieve a seamlessly cohesive diffusion bonding between the coating material and the base material of the connecting rod 1 of the motor vehicle, said diffusion bonding being without disturbing residual stresses and consequently being durable.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for coating a surface of an Fe-based, hardenable sintered, sinter-forged or forged component, the method comprising the acts of:
during the coating process, converting a coating material applied to the surface of the component to a molten state;
during the coating process, briefly heating the component surface in an untreated state of the component above an austenitization temperature to a temperature level having a significantly increased diffusion rate within limits of an outer edge zone of the component having less carbon due to a manufacturing process.

2. The method according to claim 1, wherein the outer edge zone of the component having less carbon is heated at most up to a solidus temperature subject to an effect of a laser beam.

3. The method according to claim 1, wherein the surface of the component is coated without pre-cleaning of the untreated component.

4. The method according to claim 2, wherein the surface of the component is coated without pre-cleaning of the untreated component.

5. The method according to claim 1, wherein the surface of component is coated with a Cu, Sn or Al based coating material.

6. The method according to claim 2, wherein the surface of component is coated with a Cu, Sn or Al based coating material.

7. The method according to claim 4, wherein the surface of component is coated with a Cu, Sn or Al based coating material.

8. The method according to claim 1, wherein the component is post-compacted prior to the coating operation.

9. The method according to claim 7, wherein the component is post-compacted prior to the coating operation.

10. The method according to claim 1, wherein the method internally coats a large end bore of a motor vehicle connecting rod with a bearing coating.

11. The method according to claim 10, wherein the outer edge zone of the component having less carbon is heated at most up to a solidus temperature subject to an effect of a laser beam.

12. The method according to claim 11, wherein the surface of the component is coated without pre-cleaning of the untreated component.

13. The method according to claim 10, wherein the surface of component is coated with a Cu, Sn or Al based coating material.

14. The method according to claim 12, wherein the surface of component is coated with a Cu, Sn or Al based coating material.

15. The method according to claim 10, wherein the component is post-compacted prior to the coating operation.

16. The method according to claim 14, wherein the component is post-compacted prior to the coating operation.
